(19) United States
(12) Patent Application Publication
(10) Pub. No.: US 2023/0070271 A1
(43) Pub. Date: Mar. 9, 2023

(54) SYSTEMS AND METHODS FOR IDENTIFYING ITEMS HAVING COMPLEMENTARY MATERIAL PROPERTIES

(71) Applicant: Shopify Inc., Ottawa (CA)

(72) Inventor: Byron Leonel Delgado, Ottawa (CA)

(21) Appl. No.: 17/574,712

(22) Filed: Jan. 13, 2022

Related U.S. Application Data
(60) Provisional application No. 63/241,594, filed on Sep. 8, 2021.

(51) Int. Cl. G06Q 30/06

(52) U.S. Cl. CPC G06Q 30/0627; G06Q 30/0631; G06Q 30/0643

(57) ABSTRACT

Systems and methods are provided for identifying items having material properties that are complementary to the material properties of a physical item depicted in an image. According to one embodiment, at least one captured image of a physical item associated with a user is obtained. Material properties related to one or more materials from which the physical item is formed may be determined based on analysis of the image. These material properties may include at least a type of the one or more materials. A second item having material properties that are complementary to the determined material properties may then be identified. Digital media including a representation of the first item and the second item may be generated for presentation at a user device associated with the user.

### FIELD

The present application relates to determining the material properties of items and, in particular embodiments, to identifying items having complementary material properties.

### BACKGROUND

An e-commerce platform may use product recommendations to improve customer awareness of different products sold online and help guide customers towards products that may be of interest to them. Some product recommendations may be personalized for customers. For example, a system could predict which products may be of interest to a particular customer. Recommended products may be dynamically identified and populated on a screen page that is presented to the customer. However, the effectiveness of personalized product recommendations is often limited by a lack of customer-specific data.

### SUMMARY

Systems and methods are provided for identifying two or more items having complementary material properties. In some embodiments, these systems and methods may be used to recommend a product having material properties that are complementary to a physical item owned, used or otherwise associated with a customer. The recommendation may be generated based on at least one captured image of the customer's physical item. For example, the image may be analysed to determine the material properties of the physical item. These material properties may be then used to identify one or more products sold online that have complementary material properties. The one or more products may be presented to the customer in the form of a product recommendation.

Advantageously, generating product recommendations based on material properties may better identify products that suitably match physical items already owned and/or used by a customer. In this way, the specificity and personalization of the product recommendations may be improved, which may result in improved sales of the recommended products.

Moreover, determining the material properties of a physical item based on analysis of a captured image of the item may have certain technical advantages. For example, analysing the captured image may avoid a lookup table implementation in which a large database of different items (e.g., different products sold online) and their corresponding material properties is collected, stored and searched to determine the specific material properties of the physical item. This lookup table implementation may be computationally demanding at least in terms of the storage resources needed to store the database and the processing resources needed to search the database. Further, performing analysis on the captured image may be a more reliable method to determine material properties, as this method might not require the material properties of the physical item to be predetermined and stored in a database.

According to an aspect of the present disclosure, a computer-implemented method is provided. The method may include obtaining at least one captured image of a physical item associated with a user and determining, based on the at least one captured image, material properties related to one or more materials from which the physical item is formed. The material properties may include at least a type of the one or more materials. The method may also include identifying, based on the determined material properties, a second item having material properties that are complementary to the determined material properties. The method may further include generating digital media for display at a user device associated with the user, the digital media including a representation of the first item and/or the second item.

In some embodiments, the determined material properties include at least one of roughness, ambient reflectivity, diffuse reflectivity or specular reflectivity.

In some embodiments, the second item includes a material that is the same type as the one or more materials from which the physical item is formed.

In some embodiments, the digital media includes a three-dimensional (3D) representation of the one or more materials from which the physical item is formed and/or includes a 3D representation of a material in the second item.

In some embodiments, the method includes determining that the at least one captured image is sufficient to determine the material properties related to the one or more materials from which the physical item is formed.

In some embodiments, the method includes determining that the at least one captured image is insufficient to determine the material properties related to the one or more materials from which the physical item is formed and obtaining a further captured image of the physical item. Determining the material properties related to the one or more materials from which the physical item is formed may be based on the further captured image.

In some embodiments, the method includes estimating lighting conditions in a real-world space surrounding the physical item. Determining the material properties related to the one or more materials from which the physical item is formed may be based on the lighting conditions and light interactions on a surface of the physical item as depicted in the image.

In some embodiments, the method includes determining a 3D shape of the physical item and a position of the physical item in the real-world space. Determining the material properties related to the one or more materials from which the physical item is formed may be based on the 3D shape of the physical item and the position of the physical item in the real-world space.

In some embodiments, determining the material properties related to the one or more materials from which the physical item is formed includes inputting at least a portion of the image and the lighting conditions into a machine learning (ML) model trained to identify material properties in images and obtaining, from an output of the ML model, an indication of the material properties related to the one or more materials from which the physical item is formed.

In some embodiments, the representation of the second item in the digital media depicts the second item being illuminated under the lighting conditions in the real-world space.

In some embodiments, generating the digital media is based on a 3D model of the second item. The 3D model of the second item may include a texture map corresponding to the material properties of the second item. Optionally, the 3D model of the second item is a second 3D model and generating the digital media is further based on a first 3D model of the physical item. Generating the digital media may include generating the first 3D model using photogrammetry.

According to another aspect of the present disclosure, there is provided a system including memory to store at least one captured image of a physical item associated with a user and at least one processor. The at least one processor may be to determine, based on the at least one captured image, material properties related to one or more materials from which the physical item is formed, the material properties including at least a type of the one or more materials. The at least one processor may also be to identify, based on the determined material properties, a second item having material properties that are complementary to the determined material properties and to generate digital media for display at a user device associated with the user. The digital media may include a representation of the first item and/or the second item.

In some embodiments, the second item includes a material that is the same type as the one or more materials from which the physical item is formed.

In some embodiments, the digital media includes a 3D representation of the one or more materials from which the physical item is formed and/or a 3D representation of a material in the second item.

In some embodiments, the at least one processor is to determine that the at least one captured image is sufficient to determine the material properties related to the one or more materials from which the physical item is formed.

In some embodiments, the at least one processor is to determine that the at least one captured image is insufficient to determine the material properties related to the one or more materials from which the physical item is formed and to obtain a further captured image of the physical item. The material properties related to the one or more materials from which the physical item is formed may be determined based on the further captured image.

In some embodiments, the at least one processor is to estimate lighting conditions in a real-world space surrounding the physical item. The material properties related to the one or more materials from which the physical item is formed may be determined based on the lighting conditions and light interactions on a surface of the physical item as depicted in the image.

In some embodiments, the at least one processor is to determine a 3D shape of the physical item and a position of the physical item in the real-world space. The material properties related to the one or more materials from which the physical item is formed may be determined based on the 3D shape of the physical item and the position of the physical item in the real-world space.

In some embodiments, the memory is to store a ML model trained to identify material properties in images. The at least one processor may be to input at least a portion of the image and the lighting conditions into the ML model and obtain, from an output of the ML model, an indication of the material properties related to the one or more materials from which the physical item is formed.

In some embodiments, the at least one processor executes instructions stored in a computer readable medium. For example, the computer readable medium may be the memory mentioned above, or another memory. The instructions, when executed, cause the processor to directly perform (or cause the system to perform) the method steps, e.g. the steps of determining material properties related to one or more materials from which the physical item is formed, identifying the second item, and generating the digital media for display.

According to yet another aspect of the present disclosure, there is provided a computer readable medium (which may be non-transitory). The computer readable medium stores computer executable instructions. When executed by a computer, the computer executable instructions may cause the computer to obtain at least one captured image of a physical item associated with a user; determine, based on the at least one captured image, material properties related to one or more materials from which the physical item is formed, the material properties including at least a type of the one or more materials; identify, based on the determined material properties, a second item having material properties that are complementary to the determined material properties; and generate digital media for display at a user device associated with the user, the digital media including a representation of the first item and the second item.

### BRIEF DESCRIPTION OF THE DRAWINGS

Embodiments will be described, by way of example only, with reference to the accompanying figures wherein:

FIG. 1 is a block diagram of an e-commerce platform, according to an embodiment;

FIG. 2 is an example of a home page of an administrator, according to an embodiment;

FIG. 3 illustrates the e-commerce platform of FIG. 1, but including a materials analysis engine;

FIG. 4 is a block diagram illustrating a system for identifying items having complementary material properties, according to an embodiment;

FIG. 5 is a flow diagram illustrating a process for determining the material properties of an item, according to an embodiment;

FIG. 6 illustrates a decision tree for identifying items having complementary material properties, according to an embodiment;

FIG. 7 is a flow diagram illustrating a method for identifying items having complementary material properties, according to an embodiment;

FIG. 8 illustrates a user device displaying a screen page of an online store for configuring and requesting a product recommendation, according to an embodiment;

FIGS. 9 and 10 illustrate the user device of FIG. 8 displaying screen pages of the online store for capturing an image of a physical item;

FIG. 11 illustrates the user device of FIG. 8 displaying a screen page of the online store providing a product recommendation;

FIG. 12 illustrates the user device of FIG. 8 displaying a screen page of the online store providing a 3D representation of the recommended product; and

FIG. 13 illustrates the user device of FIG. 8 displaying a screen page of the online store providing a breakdown of the product recommendation.

### DETAILED DESCRIPTION

For illustrative purposes, specific example embodiments will now be explained in greater detail below in conjunction with the figures.

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

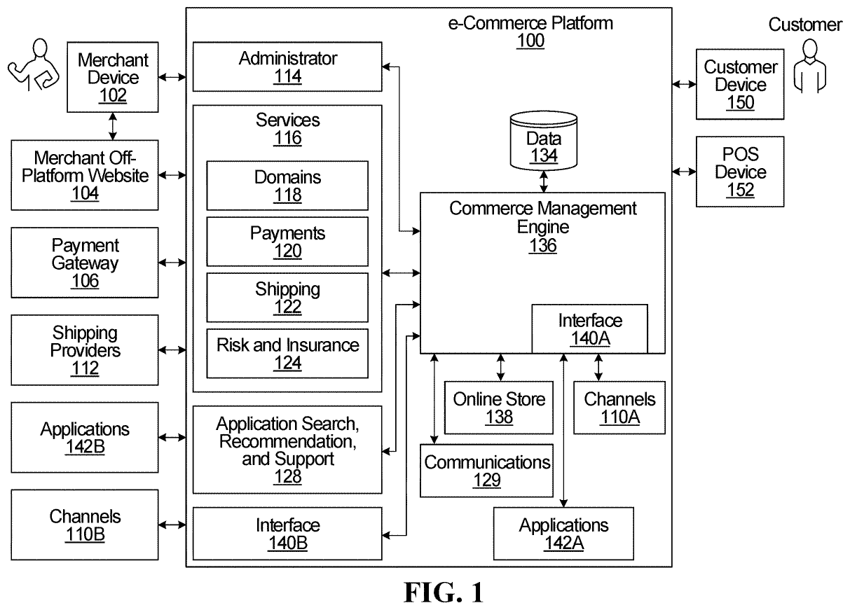

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B , channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

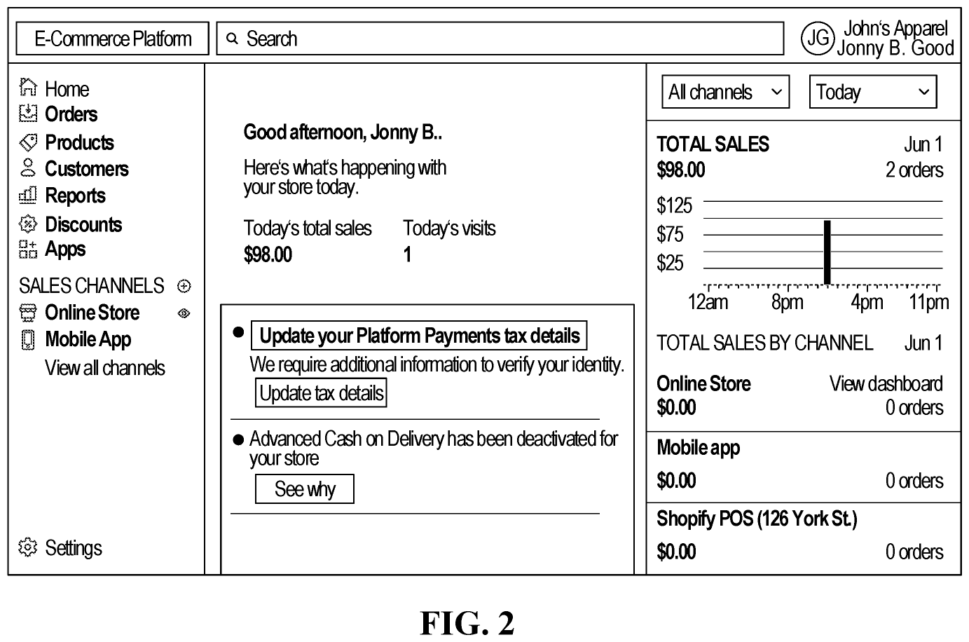

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Product Recommendations

The e-commerce platform 100 may generate product recommendations for customers. These product recommendations may help increase sales for merchants by introducing the customers to different products sold online and/or by directing the customers to products that may be of interest to them. Product recommendations may be dynamically generated based on any of a number of different factors. In some cases, the e-commerce platform 100 may dynamically generate product recommendations in a personalized or customer-specific manner. For example, product recommendations may be generated based on a customer's browsing history, search history and/or purchase history. Personalized product recommendations may be automatically generated for a customer, or a customer may request a recommendation for a product that meets one or more defined criteria. For example, a customer may request a recommendation for furniture that fits a certain theme in their home.

In some embodiments, a physical object or item that is already owned, used or otherwise associated with a customer may serve as the basis for a product recommendation. As used herein, a physical item is an item that exists in the real-world and is distinct from virtual items (i.e., items that exist only in a digital form). The customer may be interested in products that can be used and/or displayed in combination with their physical item. For example, a customer may own a couch and be interested in purchasing pillows for that couch. A customer may also or instead be interested in replacing a physical item with a similar item. For example, a customer may own a protective case for their cell phone and wish to purchase a new protective case with similar properties.

One challenge to recommending a product based on a physical item is ensuring that the materials used in the recommended product are in some way complementary to the materials in the physical item. Consider again the example in which a customer is interested in purchasing pillows for their couch. In order to suggest pillows that appropriately match the fabric of the couch, the material properties of the couch should be considered, and the pillows should be selected to match those material properties. In the example where a customer intends to replace an existing protective case for their cell phone, the material properties of the existing protective case may be analysed to help suggest a new protective case having similar properties. This may help ensure that the functionality of the new case is similar to that of the existing case. For example, a new protective case having a particular anti-slip property could be recommended based on an analysis of the material used in the customer's existing protective case.

A need exists for systems and methods to determine the material properties of an item and identify at least one other item having complementary material properties.

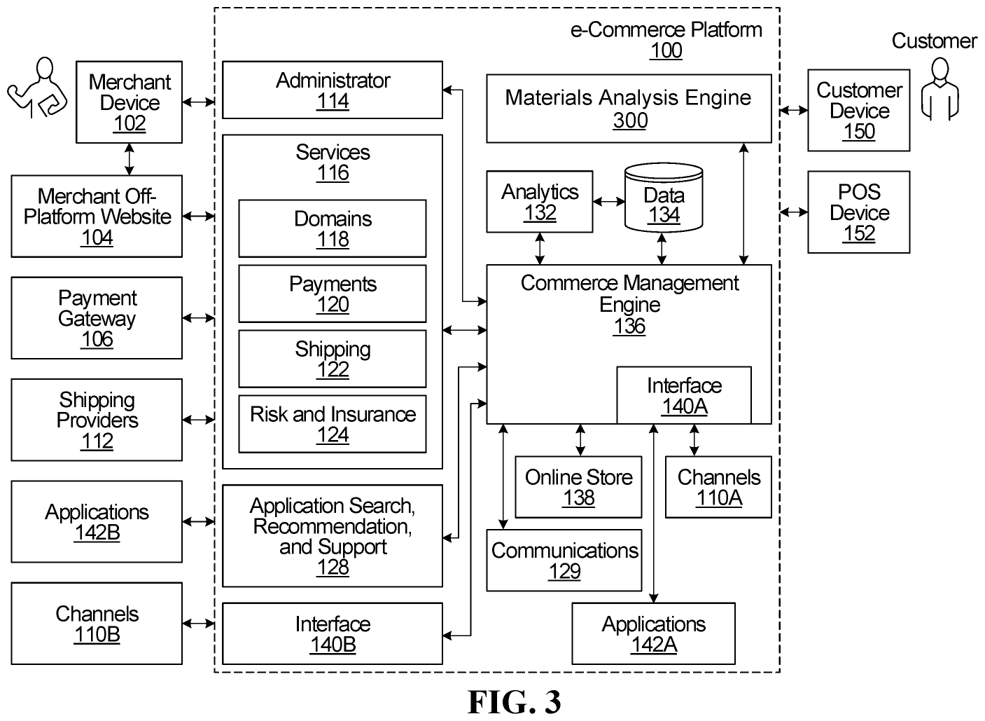

FIG. 3 illustrates the e-commerce platform 100 of FIG. 1, but including a materials analysis engine 300. The materials analysis engine 300 may be used to determine the material properties of a physical, existing item. In some implementations, one or more captured images of the physical item may be analysed by the materials analysis engine 300 to determine these material properties. The materials analysis engine 300 may then identify one or more other items based on the determined material properties of the physical item. The other items may be selected such that their material properties are complementary to the material properties of the physical item. In some cases, the material analysis engine 300 may be implemented to recommend products that are aesthetically and/or functionally appropriate for use with, or are a replacement of, one or more items that a customer already owns.

Although the materials analysis engine 300 is illustrated as a distinct component of the e-commerce platform 100 in FIG. 3, this is only an example. A materials analysis engine could also or instead be provided by another component residing within or external to the e-commerce platform 100. In some embodiments, either or both of the applications 142A-B provide a materials analysis engine that implements the functionality described herein to make it available to customers and/or to merchants. Furthermore, in some embodiments, the commerce management engine 136 provides that materials analysis engine. However, the location of the materials analysis engine 300 is implementation specific. In some implementations, the materials analysis engine 300 is provided at least in part by an e-commerce platform, either as a core function of the e-commerce platform or as an application or service supported by or communicating with the e-commerce platform. Alternatively, the materials analysis engine 300 may be implemented as a stand-alone service to clients, such as a customer device 150 or a merchant device 102. In addition, at least a portion of such a materials analysis engine could be implemented in the merchant device 102 and/or in the customer device 150. For example, the merchant device 102 could store and run a materials analysis engine locally as a software application.

As discussed in further detail below, the materials analysis engine 300 could implement at least some of the functionality described herein. Although the embodiments described below may be implemented in association with an e-commerce platform, such as (but not limited to) the e-commerce platform 100, the embodiments described below are not limited to e-commerce platforms.

### An Example System for Identifying Items Having Complementary Material Properties

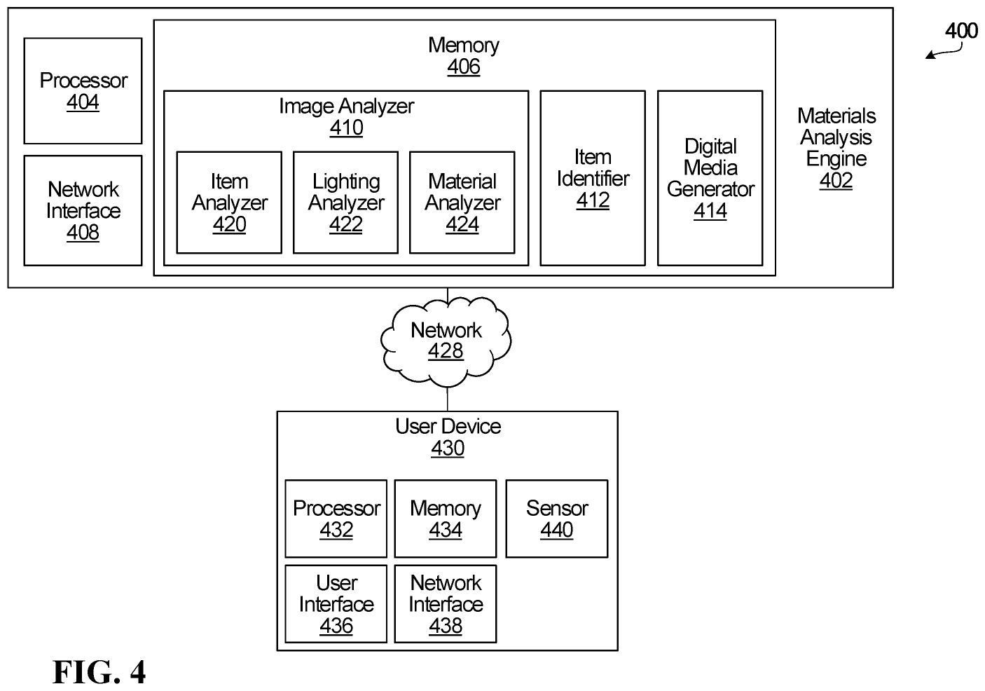

FIG. 4 is a block diagram illustrating a system 400 for identifying items having complementary material properties, according to an embodiment. The system 400 includes a materials analysis engine 402, a network 428 and a user device 430.

The materials analysis engine 402 is an example of a computing system (e.g., a server) that may be implemented within an e-commerce environment to help generate product recommendations based on the material properties of physical items owned and/or used by customers. For example, the materials analysis engine 402 may be provided by an e-commerce platform, similar to the materials analysis engine 300 of FIG. 3. However, it should be noted that the materials analysis engine 402 is in no way limited to the field of e-commerce, and may also or instead be implemented in other applications. For example, the materials analysis engine 402 may be implemented in construction applications to identify the material properties of building components and identify items having complementary material properties.

As illustrated, the materials analysis engine 402 includes a processor 404, memory 406 and a network interface 408. The processor 404 may be implemented by one or more processors that execute instructions stored in the memory 406 or in another computer readable medium. Alternatively, some or all of the processor 404 may be implemented using dedicated circuitry, such as an application specific integrated circuit (ASIC), a graphics processing unit (GPU) or a programmed field programmable gate array (FPGA).

The network interface 408 is provided for communication over the network 428. The structure of the network interface 408 is implementation specific. For example, the network interface 408 may include a network interface card (NIC), a computer port (e.g., a physical outlet to which a plug or cable connects), and/or a network socket.

The memory 406 stores an image analyzer 410, an item identifier 412 and a digital media generator 414, which are each discussed in further detail below. When the materials analysis engine 402 is implemented in the field of e-commerce, the image analyzer 410, the item identifier 412 and the digital media generator 414 may be used to generate product recommendations for customers. By way of example, a product recommendation may be generated based on one or more images of a physical item that is owned and/or used by a customer. The images of the physical item could be obtained directly from a user device associated with the customer (e.g., from the user device 430), or the images could be obtained from another system storing images associated with the customer (e.g., from a social media platform, from a product wishlist stored by an e-commerce platform, etc.). The images may be analysed using the image analyzer 410 to determine the material properties of the physical item. In some implementations, information providing context for the physical item could also be obtained to aid in analysis of the images. For example, the customer may indicate a product type or product category for the physical item. Once the material properties of the physical item are determined, the item identifier 412 might use these material properties to recommend a product that is suitable for use with the physical item. The recommended product might also or instead be suitable for replacing the physical item. The digital media generator 414 may generate digital media that depicts the recommended product, optionally in combination with the physical item, to communicate the product recommendation to the customer.

The image analyzer 410 will now be described. The image analyzer 410 may include and/or implement one or more algorithms (possibly in the form of software instructions executable by the processor 404) to analyse one or more captured images of a physical item and extract material properties related to one or more materials from which the item is formed. In some cases, material properties may be determined for different surfaces of the physical item. Non-limiting examples of material properties include roughness, color, opacity (or transparency), ambient reflectivity (e.g., the reflectivity from non-directional light sources), diffuse reflectivity (e.g., the reflectivity from directional light sources) and specular reflectivity (e.g., the level of gloss, sheen or shininess). Optionally, one or more types of materials and/or specific materials that form a physical item may be identified through analysis of an image. For example, the types of materials in the physical item may be categorized as plastic, metal, wood, paper, natural textiles, synthetic textiles, leather, fibers, glass, composite materials, minerals, stone, concrete, plaster, ceramic, rubber and/or foam. In some embodiments, different paints and/or paint layers may be identified on surfaces of the physical item.

The image analyzer 410 includes an item analyzer 420 to identify and/or characterize a physical item depicted in one or more images. The item analyzer 420 may detect the spatial features of the physical item from the images, including the surfaces, edges and/or corners of the item, for example. Detection of these spatial features may provide the three-dimensional (3D) shape and dimensions of the item. Alternatively or additionally, the item analyzer 420 may determine the 3D position (including the location and orientation) of the item in a real-world space or environment. For example, the 3D position of the item may be determined relative to surfaces, edges and/or corners of the real-world space surrounding the item. In some cases, a 3D map of the real-world space may be generated by the item analyzer 420 to better define the 3D position of the item within the space.

Any of a number of different image analysis algorithms and/or computer vision algorithms could be implemented by the item analyzer 420. Non-limiting examples of such algorithms include:

Surface, corner and/or edge detection algorithms;
Object recognition algorithms;
Motion detection algorithms; and
Image segmentation algorithms.

Further details regarding image analysis algorithms can be found in Computer Vision: Algorithms and Applications by Richard Szeliski, ISBN: 978-1-84882-935-0 (Springer, 2010), the contents of which are herein incorporated by reference in their entirety.

Inputting more than one image of a physical item into the item analyzer 420 might help determine the 3D shape and/or position of the item with a higher degree of accuracy. For example, multiple images of the item taken from different positions within a real-world space may capture more features of the item and/or more features of the real-world space. Similarly, images obtained using different sensors 440 may capture more/other features of the item and/or more/other features of the real-world space. This may provide a more complete representation of the item and/or the real-world space. The multiple images could be obtained from a video stream, from multiple different cameras and/or from multiple different sensors 440, for example. In the case that a video stream of the item is used, the item analyzer 420 could perform an initial feature detection operation to locate the features of the item and/or the real-world space. These features may then be tracked in subsequent images in the video stream. New features that are detected in the subsequent images could be used to build a more accurate 3D representation of the item and/or the real-world space.

In addition to images of a physical item, the item analyzer 420 could use other information to help determine the features of the item and/or of the real-world space surrounding the item. This additional information may be provided by a user via a user device (e.g., the user device 430). For example, a user may indicate the location of the item within an image and/or indicate the type of the item to aid in the detection of the item in the image. Alternatively or additionally, 3D information (e.g., a 3D scan of the item and/or of the real-world space) could be input into the item analyzer 420 to help determine a 3D shape of the item and/or map the real-world space. This 3D information may be stored as metadata associated with an image of the item.

Optionally, the item analyzer 420 may generate a 3D model of a physical item depicted in one or more images. The 3D model may include a mesh representing the 3D shape of the physical item and/or a texture map representing the surface appearance of the item. Other implementations of the 3D model are also contemplated, including a point cloud and/or a solid model, for example. Possible methods for generating the 3D model include photogrammetry (creating a 3D model from a series of 2D images) and 3D scanning (moving a scanner around the object to capture all angles). The 3D model may be generated and stored using any of a variety of different file formats, including GLTF, GLB, USDZ, STL, OBJ, FBX, COLLADA, 3DS, IGES, STEP, and VRML/X3D.

In some implementations, the 3D model may be generated using a predefined or default shape (e.g., a pre-modelled shape). For example, if the physical item is determined to be a particular type of item, then a default shape for that type of item could be used to define the mesh of the 3D model. A texture map of the 3D model could be generated based on the images of the physical item and be mapped to the mesh. The texture map may be a 2D image or other data structure representing the texture of the physical item as depicted in the images. Different default shapes could be stored at the materials analysis engine 402 for different types of items.

Although a default shape might not match the exact shape of a physical item, using the default shape may reduce the amount of information and/or processing required to generate a 3D model of the item. The default shape might also or instead produce higher quality 3D models (e.g., 3D models with denser meshes). By way of example, consider a case in which the item analyzer 420 determines that a couch is depicted in multiple captured images. This determination may be made based on analysis of the images and/or based on an indication provided by a user. The item analyzer 420 may then obtain a default couch shape, and optionally scale the default shape to match the dimensions of the couch depicted in the images. The item analyzer 420 may also analyse the images to generate a texture map for the couch that depicts its real-world material properties. Mapping the texture image to a mesh defined by the default couch shape might provide a realistic 3D model of the couch, even if the default couch shape does not exactly match the real-world shape of the couch.

In some implementations, the material properties of a physical item depicted in an image may be determined by identifying a specific product that corresponds to the item. The identification of a specific product may be performed by comparing the physical item to product media representing various different products. This product media may include images and/or 3D models of products sold online. By way of example, the determined 3D shape of a physical item depicted in one or more images, which may be generated by the item analyzer 420, could be compared to product media representing various products. Optionally, machine learning (ML) may be implemented to help perform the comparison between the item and the product media. If product media depicting a particular product is determined to match the physical item, then it may be determined that the item corresponds to that product. A description of the product could then be parsed to determine the material properties of the physical item.

The product media used to determine a specific product corresponding to a physical item could be stored in the memory 406 and/or be obtained by the materials analysis engine 402 from one or more external repositories, such as from an e-commerce platform, for example. Product descriptions that indicate the materials from which the products are formed could also be stored in the memory 406 and/or be obtained from one or more external repositories.

The number of different products that are compared to a physical item may be reduced based on information provided by, or otherwise associated with, a user. In some cases, this information may enable more accurate predictions of the specific product that corresponds to the physical item. For example, a user may indicate that a physical item in an image corresponds to a particular product type or to a particular product category. The online shopping history of the user might also or instead be used to reduce the number of different products that are compared to the image of the physical item. For example, images and/or 3D models of products that were actually purchased by the user on an e-commerce platform could be compared to the physical item.

There are some limitations associated with determining the material properties corresponding to a physical item by matching the item to a specific product. To practically match the item to a specific product, the product may need to have associated product media that is readily available. Some products might not be sold online (e.g., custom-made or home-sewn pillows) and therefore might not have product media that is readily available. Additionally, some products that are sold online might not have detailed product media that enables accurate comparisons with a physical item to be made. For example, a 3D model of a product might be required to accurately compare the product to a 3D representation of a physical item. However, 3D models can be expensive for merchants to generate and might not be available for every product. Further, even if a physical item depicted in an image is identified as corresponding to a specific product, then a detailed description of the product, including its material properties, may be needed. However, material properties might not always be defined and available for every product.

In view of the limitations associated with determining material properties by matching a physical item depicted in an image to a specific product, the image analyzer 410 may be implemented to directly determine the material properties of a physical item through image analysis. This may provide a more consistent and/or accurate means for determining the material properties of the item.

Determining material properties through image analysis may be a complex process. For example, cases such as where the image comprises pixel data obtained using a camera, some material properties, such as color for example, might be readily derivable from the pixels in an image. Other material properties, however, might not be directly derivable from the pixels. For example, roughness and specular reflectivity might be difficult to determine using the pixels of the image alone, especially depending on the level of zoom/resolution of the image. The images that are a representation of data obtained from other sensors may allow other properties to be derived or estimated, directly or indirectly, therefrom. For example, an image that is a representation obtained using LiDAR (Light Detection and Ranging)—such as, for example, a representation of a LiDAR sensor spectral reflectance data set—may render roughness and specular reflectivity directly derivable. As another example, an image that is a representation obtained using sonar (sound navigation and ranging)—such as, for example, a representation of a sonar sensor reflection intensity data set—may allow the material or materials forming an item to be derived or estimated directly therefrom.

Determining the lighting conditions that illuminate a physical item in an image may help determine the material properties of the item with a higher degree of accuracy. The image analyzer 410 includes a lighting analyzer 422 to characterize the lighting conditions depicted by one or more images. These lighting conditions may define the different sources of light in a real-world space and/or the reflections of light in a real-world space, for example.

The lighting analyzer 422 may extract lighting conditions from images in any of a number of different forms. In some implementations, lighting conditions may be characterized in terms of the properties of one or more light sources that illuminate a real-world space. The properties of a light source may include a type of light source (e.g., a point light source, a directional light source, a spotlight, ambient light, etc.). Alternatively or additionally, the properties of a light source may include the 3D position (including the location and orientation) of the light source within a real-world space. The position of a light source may be defined in relation to the 3D features of the real-world space. Other properties of a light source may include the brightness or intensity of the light source (e.g., in lumens), the color of the light source (e.g., in terms of the red-green-blue (RGB) color model or in terms of color temperature in Kelvin), the directionality of the light source and/or the spread of the light source.

The properties of a light source may be extracted from an image in any of a number of different ways. In some implementations, the light interactions depicted on various surfaces in the image may be analyzed to determine the light sources that may have produced those interactions. Light interactions represent how light from a light source interacts with a surface of an item. Light interactions on a surface are generally based on the material properties of the surface and the properties of the light source(s) illuminating the surface. In some cases, light interactions may be broken down into diffuse, ambient and specular light interactions. Diffuse lighting is the directional light that is reflected by a surface from a light source and may provide the main component of a surface's brightness and color. Ambient lighting is directionless light reflected from ambient light sources. Specular lighting provides shine, gloss, sheen and highlights on a surface from a light source and may be based on the specular reflectivity properties of the surface. The diffuse, ambient and/or specular light interactions shown on a surface in an image may be used to determine the properties of one or more light sources. If the material properties of the surface are known or can be determined, then these material properties may be used to help determine the properties of the light sources. Reflections on the surface may also or instead be used to determine the properties of the light sources.

In some implementations, the lighting analyzer 422 may extract lighting conditions from one or more images in the form of an environment map corresponding to a real-world space. The environment map may combine content in the images to provide a cohesive digital representation of the real-world space. For example, the environment map may be formed, at least in part, from background content in the images. Alternatively or additionally, the light interactions depicted on different surfaces in the images may be used to help determine at least a portion of the environment map (e.g., locate blobs of light and/or dark areas in the real-world space based on light interactions on surfaces). The images may be organized to form the interior surfaces of a sphere or cube depicting the real-world space. The center of the sphere or cube may correspond to a location where the images were captured.

Metadata associated with an image might be used to help determine lighting conditions in some cases. For example, metadata for an image might include the time of day the image was captured, the location where the image was captured, the properties of a camera flash used to capture the image, and/or the properties of a sensor (e.g. a sonar or LiDAR sensor) used to capture the image. The time of day that the image was captured and/or the location where the image was captured may be used to help determine the properties of natural sunlight in the image. Similar information may be used in combination with other sensor data to adjust a data set to reflect the interaction of the natural sunlight on the measurements. In some implementations, metadata for an image might include an environment map created in a mapping process that is separate from capturing the image. For example, a user may perform a scan of a room to create an environment map. The environment map may then be stored as metadata attached to images that are captured in the room.

The image analyzer 410 further includes a material analyzer 424 to determine the material properties related to one or more materials from which a physical item is formed. The inputs to the material analyzer 424 may include one or more images of the physical item. Alternatively or additionally, inputs to the material analyzer 424 may include outputs from the item analyzer 420 and/or outputs from the lighting analyzer 422. For example, the material analyzer 424 might determine the material properties of a physical item based on the 3D shape and position of the item, and on the lighting conditions in a real-world space surrounding the item.

In some implementations, the material analyzer 424 may quantify or otherwise characterize the light illuminating the surfaces of a physical item to help determine the material properties of the item. For example, the material analyzer 424 may calculate the properties of the light illuminating the surfaces of the physical item based on the 3D position and orientation of each surface relative to the lighting conditions in a real-world space. The properties of light illuminating a surface may include, inter alia, the intensity of the light, the color of the light and/or the directionality of the light. Computer graphics lighting models may be used to calculate the properties of light illuminating one or more surfaces of a physical item. Possible lighting models that may be used include the Lambert model, the Phong illumination model, the Blinn-Phong illumination model, radiosity, ray tracing, beam tracing, cone tracing, path tracing, volumetric path tracing, Metropolis light transport, ambient occlusion, photon mapping, signed distance field and image-based lighting, for example. In some implementations, a light map for a physical item may be generated to characterize the light illuminating each surface of the item. A lightmap is a precalculated representation of the illumination of a 3D object. A light map may be used to define the illumination of any, some, or all of the surfaces of the physical item. The light map may be mapped to a 3D model of the physical item generated by the item analyzer 420, for example. Alternatively or additionally, the material analyzer 424 may obtain an image that is derived using LiDAR—such as, for example, a representation of a LiDAR sensor spectral reflectance data set—to characterize and/or assist in characterizing the light illuminating the surfaces of a physical item.

Once the properties of the light illuminating one or more surfaces of a physical item are determined, the material analyzer 424 may correlate these properties with the light interactions depicted on those surfaces in one or more images. In one example, surface roughness on the physical item may be detected based on the lighting conditions and the shadows cast on the surfaces of the item. If the lighting conditions indicate that light is incident on a surface of the item at an acute angle, but very few/small shadows are apparent on that surface, then it might be determined that the surface is smooth. Alternatively, if multiple large shadows are apparent on the surface of the item, then it might be determined that the surface is rough. In another example, specular reflectivity may be determined based on the level of glare depicted on surfaces of the item that are closest to bright light sources. In yet another example, the “true” color of a surface may be determined based on the color depicted in an image and the color of the light illuminating the surface (e.g., a white surface depicted in an image might appear blue when illuminated with a blue light, but knowledge of the properties of the blue light may allow the “true” white color of the surface to be determined).

The material analyzer 424 may be implemented in any of a number of different ways. In some implementations, the material analyzer 424 may include a lookup table or another digital library that relates the properties of light illuminating a surface and the light interactions depicted on that surface to the material properties of the surface. In some implementations, the material analyzer 424 may include machine learning algorithms and/or other predictive algorithms to help determine the material properties of a physical item depicted in an image. For example, a machine learning (ML) model could be trained to identify material properties of a physical item from an image. Inputs to the ML model could include an image of a physical item, the lighting conditions in a real-world space, the 3D shape of the item and/or the 3D position of the item. The ML model could output predicted material properties for the physical item. A training data set for the ML model may be formed using images that depict objects with known material properties. This training data set could be obtained from a product catalogue stored by an e-commerce platform, for example. Non-limiting examples of ML model structures include artificial neural networks, decision trees, support vector machines, Bayesian networks, and genetic algorithms. Non-limiting examples of training methods for an ML model include supervised learning, unsupervised learning, reinforcement learning, self-learning, feature learning, and sparse dictionary learning.

The material properties corresponding to a physical item determined by the material analyzer 424 may include a type of one or more materials from which the item is formed. For example, the material analyzer 424 may define multiple different material types and determine which material type best describes a surface of the physical item. Non-limiting examples of material types include plastics, metal, wood, paper, natural textiles, synthetic textiles, leather, fibers, glass, composite materials, minerals, stone, concrete, plaster, ceramic, rubber and foam. The material analyzer 424 may also or instead identify a specific material from which a physical item is formed. This specific material may be identified using a part number or another unique identifier for the material. For example, a specific paint code (e.g., identifying a particular color, sheen, and/or the like) might be determined for a painted surface of the physical item.

The material analyzer 424 may determine that a surface of an item includes multiple different materials. For example, a surface of a vehicle may be determined to be an aluminum base material with several paint layers applied on top.

In some implementations, the image analyzer 410 may determine the material properties of a physical item during an augmented reality (AR) experience implemented by a user. Images of the item captured during the AR experience could be input into the image analyzer 410. Optionally, other data obtained during the AR experience could be input into the image analyzer 410. For example, a simultaneous localization and mapping (SLAM) process performed during the AR experience could be used to help determine the lighting conditions in a real-world space, the 3D shape of the item and/or the position of the item.

In some implementations, the image analyzer 410 may determine the material properties of a physical item from an image that is obtained using sonar such as, for example, from a representation of a sonar sensor data set. Images of the item captured with sonar can be input into the image analyzer 410. Optionally, other representations of data obtained during the sonar image creation or derived therefrom could be input into the image analyser 410. For example, an image that is the representation of a sonar reflection intensity data set of the item could be used to help determine the item materials. Additionally or alternatively, an image that is a representation of a sonar distance data set could be used to help determine the 3D shape and/or position of the item, possibly with a higher degree of accuracy. Such a sonar image may, additionally or alternatively, be employed to allow the default shape to be obtained such as in the item analyzer 420. The mesh of the 3D model may correspond to this default shape obtained from the sonar image.

In some implementations, the image analyzer 410 may determine the material properties of a physical item from an image that is obtained using LiDAR such as, for example, from a representation of a LiDAR sensor data set. Images of the item captured with LiDAR can be input into the image analyzer 410. Optionally, other representations of data obtained during the LiDAR image creation or derived therefrom could be input into the image analyser 410. For example, an image that is the representation of a LiDAR spectral reflectance data set of the item could be used to help determine the item materials. Additionally or alternatively, an image that is a representation of a LiDAR distance data set could be used to help determine the 3D shape and/or position of the item, possibly with a higher degree of accuracy. Additionally or alternatively, the LiDAR image may be employed to allow the default shape to be obtained such as in the item analyzer 420. The mesh of the 3D model may correspond to this default shape obtained from the LiDAR image.

The image analyser 410 may also determine the material properties of a physical item from any combination of the image capturing methods disclosed herein.

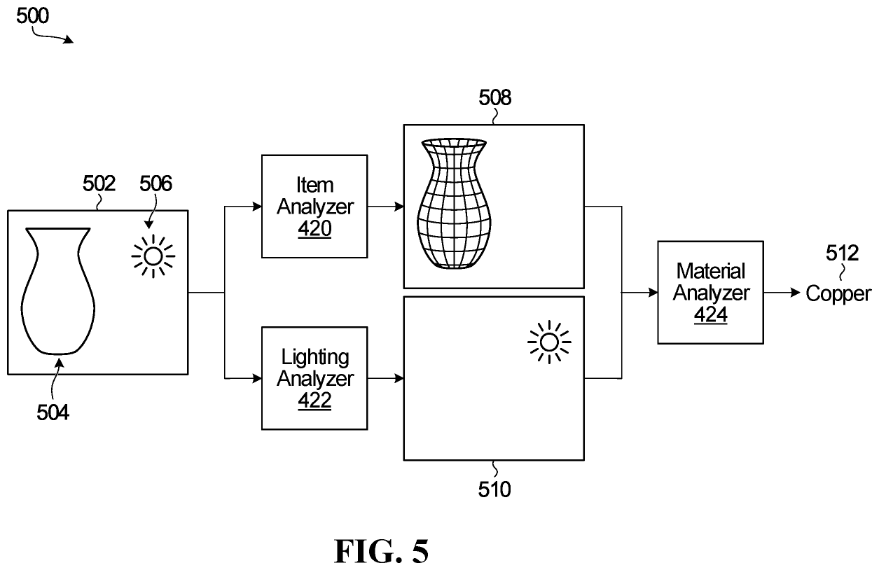

FIG. 5 is a flow diagram illustrating an example process 500 implemented by the image analyzer 410 of FIG. 4. In the process 500, a captured image 502 of a physical item 504 is being analysed to determine the material properties of the item 504. The image 502 also depicts a light source 506 that illuminates the item 504. In this example, the light source 506 is the only light source that illuminates the item 504.

The image 502 is input into both the item analyzer 420 and the lighting analyzer 422. The item analyzer 420 outputs a 3D model 508 of the item 504. The 3D model 508 may provide a mathematical representation of the item 504 that is defined with a length, width, and height. The 3D model 508 may be limited to only representing the item 504, and therefore the light source 506 might not be represented by the 3D model 508.

The lighting analyzer 422 outputs lighting conditions 510 that represent the lighting depicted in the image 502. In some implementations, the lighting conditions 510 may characterize the properties of the light source 506. Alternatively or additionally, the lighting conditions 510 may include an environment map of the real-world space surrounding the item 504, which includes the light source 506.

The 3D model 508 and the lighting conditions 510 are input into the material analyzer 424. The material analyzer 424 may use the 3D model 508 and the lighting conditions 510 to determine the properties of the light illuminating the surfaces of the item 504 in the image 502. These properties may then be correlated with the light interactions depicted on the surfaces of the item 504 in the image 502 to determine the material properties that would produce those light interactions. In the illustrated example, the material analyzer 424 produces an output 512 indicating that the item 504 is made, at least in part, from copper. Copper may be a type of material identified by the material analyzer 424.

While FIG. 5 only illustrates one image being analysed by the image analyzer 410, it should be noted that multiple images of the item 504, which may be taken from different perspectives in a real-world space, could also be analysed to potentially improve the accuracy of the determined material properties.

Once the material properties of a physical item in an image are determined, and optionally the types of materials and/or the specific materials that form the item are identified, another item having complementary material properties may be identified. Referring again to the materials analysis engine 402 of FIG. 4, the item identifier 412 may include and/or implement one or more algorithms (possibly in the form of software instructions executable by the processor 404) to select at least one item having material properties that are complementary to the determined material properties of a physical item. These determined material properties may have been obtained from the image analyzer 410, for example.

Two items may have complementary material properties in any of a number of different ways. In some cases, two items that include similar or even identical materials could be considered to have complementary material properties. Similar materials may be materials that are the same type of material. However, two items need not always include similar materials for those items to have complementary material properties. For example, two items having complementary material properties could have different but aesthetically harmonious colors. Alternatively or additionally, two items having complementary material properties could be made from the same base material, but have different colors, patterns and/or structures. For example, suede pillows could be considered complementary to a suede couch, regardless of the patterns on the pillows. Alternatively or additionally, two items having complementary material properties could provide similar functionality, but differ in the composition of their base material. For example, rain pants made of a first water-proof material could be considered complementary to a rain jacket made of a second water-proof material, even if the first and second water-proof materials are different. Other examples of complementary materials are also contemplated. It should also be noted that whether or not two materials are considered to be complementary may depend on the application. For example, two fabrics that are considered to be complementary when used in clothing might not be considered complementary when used in furniture.

In some cases, the item identifier 412 might identify multiple different items having material properties that are complementary to a physical item. These different items may have different forms of complementary material properties. For example, each of the different items might complement the physical item in different ways. Certain complementary material properties might be prioritized over others. As an example, items that are complementary in a functional nature might be prioritized over materials that are complementary in an aesthetic nature. As another example, items that are complementary in more than one way (e.g., in both a functional nature and an aesthetic nature) may be prioritized. In this way, the item identifier 412 might order or rank different items that are determined to have material properties complementary to the material properties of a physical item.

In some implementations, the item identifier 412 may search for a recommended item having a specific set of complementary material properties. This specific set of complementary material properties may be derived, at least in part, from user input. For example, a user may own a chair made from a specific fabric and request a recommendation for items that use the same or a substantially similar fabric.

Factors other than the material properties corresponding to a physical item may be used to help identify a complementary item. For example, in e-commerce applications, the location of a customer may be taken into account by the item identifier 412. If the customer lives in a warm climate and is looking for clothing, then warmer materials such as wool may be filtered out.

Defined design rules may be implemented by the item identifier 412 to identify items having complementary material properties. In some implementations, the item identifier 412 may include a library of different items and the corresponding material properties of each item. The items may be identified in the library using a brand name, a manufacturer part number (MPN), a global trade item number (GTIN), and/or a stock keeping unit (SKU), for example. The library may also identify the material properties that each item complements according to defined design rules. An item having complementary material properties to a physical item may then be selected from the library based on the determined material properties of the physical item. In some cases, the library of different items may include or correspond to a catalogue of products sold online.

By way of example, one entry in a library of items stored by the item identifier 412 may be a particular scarf. The library may store the material properties corresponding to the scarf, including:

material type=wool;
color=red;
roughness=coarse;
opacity=opaque; and
specular reflectivity=low.

The library may also store material properties that are complementary to the material properties of the scarf, including:

complementary material types=wool, flannel and cotton;
complementary colors=red, black and white;
complementary roughness=coarse;
complementary opacity=opaque; and
complementary specular reflectivity=low.

In some implementations, the item identifier 412 may select the scarf as a recommended product if a particular physical item has a set of material properties that match the complementary material properties stored for the scarf. Other factors, such as whether the physical item is an item of clothing, for example, might also be considered when selecting the scarf as a recommended product.

In some implementations, the item identifier 412 may include a decision tree that analyzes the determined material properties corresponding to a physical item and outputs one or more items having complementary material properties. For example, the decision tree may include a series of decisions that are answered based on the determined material properties of a physical item. Each decision may have an associated set of options that lead to the next set of decisions or, at a final decision, lead to a set of items having complementary material properties. The decisions and options in the decision tree may be generated based on defined design rules, for example.

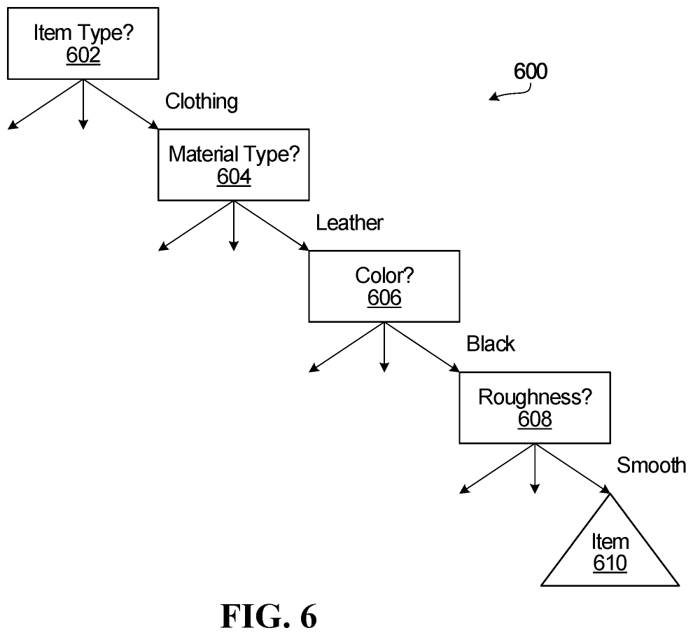

FIG. 6 illustrates an example of a decision tree 600 that may be implemented by the item identifier 412 of FIG. 4. The decision tree 600 includes multiple decision nodes 602, 604, 606, 608 that correspond to queries regarding the properties of a physical item, including queries regarding the material properties of the item. The decision tree 600 also includes an end node 610 that corresponds to an output of the decision tree 600. Although only five nodes are shown in FIG. 6, the decision tree 600 may also include additional nodes. Multiple options (shown as arrows) stem from each of the decision nodes 602, 604, 606, 608 and link the different nodes of the decision tree 600. As illustrated, each of the decision nodes 602, 604, 606, 608 has three associated options; however, this is only an example. Decision nodes may also have more or less than three options. It should be noted that only one option is labelled for each of the nodes 602, 604, 606, 608 to avoid congestion in FIG. 6. The unlabelled options may lead to decision nodes and end nodes that are not illustrated in FIG. 6.

Consider, by way of example, an implementation of the decision tree 600 to identify items having material properties that are complementary to the determined material properties of a particular jacket. The decision tree 600 begins with the decision node 602, which queries the item type for the jacket. One option that is selectable from the decision node 602 is “clothing”, which directs the inquiry to the decision node 604. Selecting “clothing” at the decision node 602 may limit the outputs of the decision tree 600 to other items of clothing. The decision node 604 queries the material type for the jacket. Selecting the “leather” option at the decision node 604 directs the inquiry to the decision node 606. The decision node 606 queries the color of the jacket. Selecting the “black” option at the decision node 606 directs the inquiry to the last decision node 608, which queries the roughness of the jacket. Selecting the “smooth” option directs the inquiry to the end node 610 that identifies a set of one or more items having material properties that are complementary to smooth black leather materials, such as those found in the jacket.

Referring again to the materials analysis engine 402 of FIG. 4, the digital media generator 414 may include and/or implement one or more algorithms (possibly in the form of software instructions executable by the processor 404) to generate digital media that presents items to users, including items that have been selected by the item identifier 412. Non-limiting examples of digital media that may be generated by the digital media generator 414 include images, videos and 3D models.

In e-commerce applications, the digital media generator 414 could generate digital media to present a recommended product to a customer. The digital media may also depict a physical item owned by the customer that was used to identify the recommended product. The digital media may enable the customer to appreciate how the recommended product complements their item. The digital media may be presented to the customer via a screen page or other graphical user interface displayed on the customer's device.

In some cases, digital media generated by the digital media generator 414 might present multiple different recommended products and/or different variants of a recommended product. Consider, by way of example, a case in which a customer is searching for pillows that match their couch. The item identifier 412 may select multiple pillow fabrics that complement the material properties of the couch. The digital media generator 414 may then generate digital media presenting swatches of each of those fabrics.

The digital media generator 414 may generate digital media based on a 3D model of an item selected by the item identifier 412, which will be referred to as a “selected item”. The material properties of the selected item may be illustrated in the form of a texture map for the 3D model. The 3D model of the selected item may have been obtained from an external repository of 3D models, such as from a product media catalogue stored on an e-commerce platform, for example. In some implementations, the 3D model of the selected item may be displayed alongside a physical item that was used to identify the selected item. For example, the 3D model of the selected item may be incorporated into an AR experience that includes the physical item. Alternatively or additionally, 3D models of both the physical item and the selected item may be used to better illustrate the combination of the items. The 3D model of the physical item may be obtained from the item analyzer 420, for example. A composite 3D model that includes the 3D model of the physical item and the 3D model of the selected item could be generated and presented to a user. The lighting conditions determined by the lighting analyzer 422 may be used to light the composite 3D model.

In one example, a 3D model of a customer's couch could be generated based on one or more images of the couch, and a 3D model of a recommended pillow could be combined with the 3D model of the couch to illustrate how the material of the pillow might complement the material of the couch. In another example, a 3D model of a customer's cell phone could be generated, and a 3D model of a recommended protective case could be combined with the 3D model of the cell phone to illustrate the fit of the case.

In addition to providing visual representations of the physical item and/or the second item, a 3D model may also have associated audio content and/or haptic content. For example, a 3D model could store sounds made by or otherwise associated with an item and/or haptic feedback that can simulate the feel of an item.

The network 428 in the system 400 may be a computer network implementing wired and/or wireless connections between different devices, including the materials analysis engine 402 and the user device 430. For example, the materials analysis engine 402 may receive images from the user device 430 and/or transmit digital media to the user device 430 via the network 428. The network 428 may implement any communication protocol known in the art. Non-limiting examples of communication protocols include a local area network (LAN), a wireless LAN, an internet protocol (IP) network, and a cellular network.

The user device 430 may be or include a mobile phone, smart watch, tablet, laptop, projector, headset and/or computer. The user device 430 includes a processor 432, memory 434, user interface 436, network interface 438 and sensor 440. The user interface 436 may include, for example, a display screen (which may be a touch screen), a gesture recognition system, a speaker, headphones, a microphone, haptics, a keyboard, and/or a mouse. The user interface 436 may present digital content to a user, including visual, haptic and audio content. In some implementations, the user device 430 includes implanted devices or wearable devices, such as a device embedded in clothing material, or a device that is worn by a user, such as glasses.

The network interface 438 is provided for communicating over the network 428. The structure of the network interface 438 will depend on how the user device 430 interfaces with the network 428. For example, if the user device 430 is a mobile phone, headset or tablet, then the network interface 438 may include a transmitter/receiver with an antenna to send and receive wireless transmissions to/from the network 428. If the user device is a personal computer connected to the network 428 with a network cable, then the network interface 438 may include, for example, a NIC, a computer port, and/or a network socket.

The processor 432 directly performs or instructs all of the operations performed by the user device 430. Examples of these operations include processing user inputs received from the user interface 436, preparing information for transmission over the network 428, processing data received over the network 428, and instructing a display screen to display information. The processor 432 may be implemented by one or more processors that execute instructions stored in the memory 434. Alternatively, some or all of the processor 432 may be implemented using dedicated circuitry, such as an ASIC, a GPU or an FPGA.

The sensor 440 may enable photography, videography, distance measurements, 3D scanning and/or 3D mapping (e.g., SLAM) at the user device 430. For example, the sensor 440 may include one or more cameras, radar sensors, LiDAR sensors, sonar sensors, accelerometers, gyroscopes, magnetometers and/or satellite positioning system receivers (e.g., global positioning system (GPS) receivers). The camera may be used to capture images of physical items. Measurements obtained by the sensor 440 may help to enable augmented reality (AR), mixed reality (MR) and/or extended reality (XR) experiences on the user device 430. The measurements obtained by the sensor 440 may, additionally or alternatively, be used to generate one or more images that are the representation (e.g. visual representation) of the data set(s) obtained by the measurements. Although the sensor 440 is shown as a component of the user device 430, at least a portion of the sensor 440 may also or instead be implemented separately from the user device 430 and may communicate with the user device 430 via wired and/or wireless connections, for example.

Although only one user device is shown in FIG. 4, it should be noted that multiple user devices may be implemented in the system 400.

### An Example Method for Identifying Items Having Complementary Material Properties

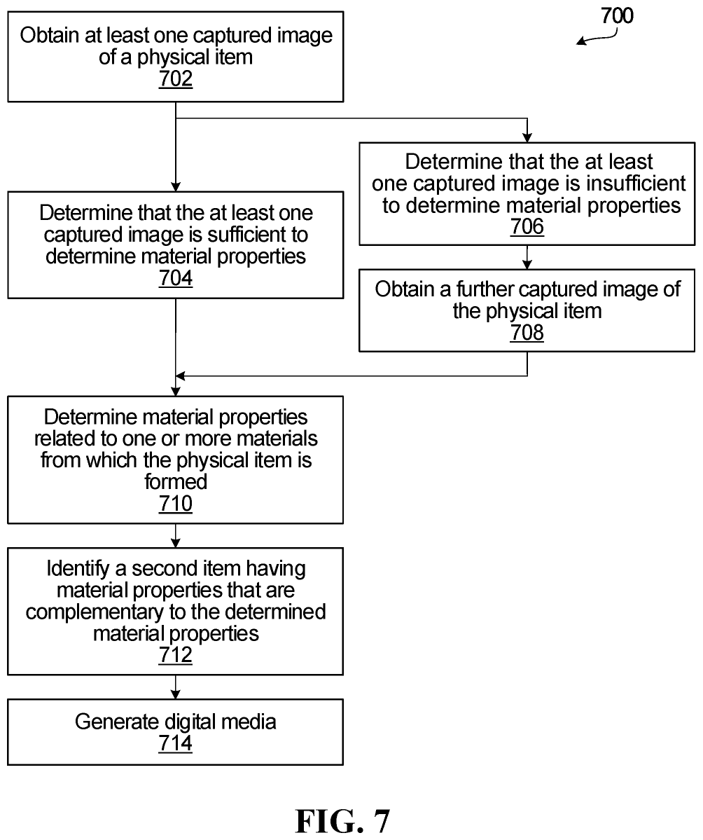

FIG. 7 is a flow diagram illustrating a method 700 for identifying items having complementary material properties, according to an embodiment. The method 700 will be described as being performed by the materials analysis engine 402 of FIG. 4. For example, the memory 406 may store instructions which, when executed by the processor 404, cause the processor 404 to perform the method 700. However, this is only one example implementation of the method 700. The method 700 may be more generally be performed by other systems and devices, such as by the user device 430, for example.

The method 700 may be implemented in the field of e-commerce to generate product recommendations for a customer based on an image of a physical item owned and/or used by the customer. In some cases, the materials analysis engine 402 may automatically perform the method 700, without receiving any explicit instructions from the customer. For example, the method 700 may be performed to generate personalized marketing material for presentation to the customer. Alternatively, the customer may transmit a request for a product recommendation, and the materials analysis engine 402 may perform the method 700 in response to the request. The request may be transmitted as a hypertext transfer protocol (HTTP) or HTTP secure (HTTPS) message from the user device 430, for example. The customer might also specify criteria or filters for the product recommendation. These criteria or filters may limit the recommended products to certain product categories, product types, product brands, product dimensions and/or a cost range. For example, the customer may limit a recommendation to home decorating products. The customer might also indicate whether a recommended product is intended to be used in combination with their item or is intended to replace their item.

Step 702 includes the processor 404 obtaining at least one captured image of a physical item associated with a user (e.g., the user may own and/or use the physical item). The captured image may be obtained by a camera, e.g. it may be pixel data obtained using the camera such as for example, using a CCD (charge coupled device) image sensor and/or a CMOS (complimentary metal oxide semiconductor) image sensor. However, more generally, the captured image may be any representation of the physical item obtained from the measurements of the sensors 440 and is not limited to an image taken from a camera. For example, the captured image may be a representation of distance data (e.g. a distance measurement data set) of a sensor such as, for example, a LiDAR sensor or sonar sensor. Additionally or alternatively, the captured image may also be a representation of multiple measurements obtained using the sensors. For example, the captured image may be a representation of both the distance measurement data set as well as the spectral reflectance data set obtained using LiDAR via the LiDAR sensor.

The at least one captured image may be stored, at least temporarily, in the memory 406. In some implementations, the image may have been transmitted to the materials analysis engine 402 from the user device 430. The user may capture the image of the physical item using the sensor 440 on the user device 430 and transmit the image to the materials analysis engine 402 in an HTTP or HTTPS message. In this way, the user may directly provide the image. However, the user need not always directly provide the image. In some implementations, the image may be obtained from an external repository of images associated with the user. One example of such an external repository is a social media platform. The materials analysis engine 402 may obtain images from the user's account on the social media platform in step 702. Another example of an external repository of images associated with the user is an e-commerce platform. The materials analysis engine 402 may obtain images of products that the user has purchased or products that the user intends to purchase (e.g., products in a product shopping cart or a wishlist) from the user's account on the e-commerce platform in step 702.

Multiple images of the physical item may be obtained in step 702 that show the item from different perspectives in a real-world space. These multiple images may be provided in the form of a video, for example. In some implementations, other information pertaining to the physical item and/or to the real-world space may be obtained in step 702. This other information may include 3D information obtained from scans of the physical item and/or of the real-world space. The other information may also or instead include descriptive information pertaining to the physical item, such as indications of an item type for the physical item, for example. Non-limiting examples of item types include clothing, furniture and kitchen appliances. In some embodiments, a user may provide an indication of where the physical item is located in one or more images. For example, using the user interface 436 at the user device 430, the user may select the physical item in the image or draw a boundary around the item in the image.

In some cases, the method 700 may be performed in conjunction with an AR experience implemented by the user device 430. One or more images of the physical item may be obtained from the AR experience in step 702. Optionally, 3D information generated through a SLAM process, for example, may also or instead be obtained from the AR experience in step 702.

In some implementations, the materials analysis engine 402 may determine whether or not the at least one captured image of the physical item obtained in step 702 provides enough information to determine the material properties related to the one or more materials from which the item is formed. Optional step 704 includes the processor 404 determining that the at least one captured image is sufficient to determine the material properties. For example, the number of images, clarity of the images, brightness of the images, resolution of the images, data errors present in the image representation, and/or variance in the data set in the image representation may be analysed by the image analyzer 410 to determine that the at least one captured image is sufficient.

Alternatively, optional step 706 includes the processor 404 determining that the at least one captured image is insufficient to determine the material properties related to the one or more materials from which the physical item is formed. This determination may be performed by the image analyzer 410 based on the number of images, clarity of the images, brightness of the images, resolution of the images, data errors present in the image representation, and/or variance in the data set in the image representation. Optional step 708 then includes the processor 404 obtaining at least one further captured image of the physical item. The further captured image may be obtained from the same source as the image obtained in step 702. For example, if an image is obtained from the user device 430 in step 702, then step 708 might include transmitting a request for a further image to the user device 430 (e.g., in an HTTP or HTTPS message) and receiving the further captured image in response. Alternatively or additionally, if an image is obtained in step 702 from an external repository of images, then the external repository may be searched for a further image of the physical item in step 708. Alternatively or additionally, the further captured image may be obtained from a different source compared to the image obtained in step 702. For example, if the captured image is obtained from a camera of the user device 430 in step 702, then step 708 might include obtaining (e.g. transmitting a request for) an image of a representation from a sonar or LiDAR sensor. In some embodiments, a request may be sent to the user device 430 (e.g., in an HTTP or HTTPS message) and receiving the further captured image in response.

By way of example, an image of the physical item obtained in step 702 using a camera may have been captured by the user device 430 in a relatively dark room. Step 706 may include determining that the lighting conditions in the room are too dark to properly illustrate the material properties of the physical item. Step 708 might include transmitted feedback for display on the user device 430 indicating that the user should increase the brightness of the room or use the camera's flash. Alternatively or additionally, step 708 might include transmitted feedback for display on the user device 430 indicating that the user should capture the image with a different sensor 440 that may not be and/or may be less affected by the dark lighting conditions (e.g. a sonar sensor or LiDAR sensor). In another example, a single image of the item captured by the user device 430 may have been obtained in step 702. Step 706 might include determining that the single image does not provide enough information to determine the 3D shape of the physical item and/or the 3D position of the item in the real-world space. Step 708 might then include transmitting feedback for display on the user device 430 indicating that the user should capture additional images of the physical item from different angles that might better illustrate the item.

Step 710 includes the processor 404 determining the material properties related to one or more materials from which the physical item is formed. Step 710 may be performed using the material analyzer 424 based on the at least one captured image obtained in step 702 and, optionally, based on a further captured image obtained in step 708.

In some implementations, the material properties determined in step 710 may include at least one of roughness, transparency, ambient reflectivity, diffuse reflectivity, specular reflectivity or color. Alternatively or additionally, the determined material properties may include a type of the one or more materials from which the physical item is formed. Examples of different types of materials are provided elsewhere herein. Advantageously, determining the type of the one or more materials may provide a detailed understanding of the material properties of the physical item that goes beyond superficial material properties such as color, for example. The type of the one or more materials may indicate the functional properties of the materials, including, inter alia, durability, waterproofness and hardness.

In some implementations, step 710 may include estimating lighting conditions in a real-world space surrounding the physical item. The material properties related to the one or more materials from which the physical item is formed may then be determined based, at least in part, on the lighting conditions and on the light interactions on one or more surfaces of the physical item as depicted in an image. For example, and as discussed elsewhere herein, the lighting conditions may be correlated with the light interactions depicted on a surface of the physical item in an image to help deduce the material properties of that surface. The lighting conditions may be estimated using the lighting analyzer 422 based on the at least one captured image obtained in step 702 and, optionally, based on a further captured image obtained in step 708.

In some implementations, step 710 may include determining a 3D shape of the physical item and a 3D position of the physical item in a real-world space. The material properties related to the one or more materials from which the physical item is formed may then be determined based, at least in part, on the 3D shape of the physical item and the position of the physical item. For example, the 3D shape and the 3D position of the physical item may be used to determine the location and orientation of surfaces on the physical item relative to the lighting conditions in the real-world space, which may help determine the properties of light illuminating those surfaces. The properties of light illuminating a surface may be correlated with the light interactions depicted on the surface to deduce the material properties of the surface. The item analyzer 420 may be used to determine the 3D shape of the physical item and the 3D position of the physical item based on the at least one captured image obtained in step 702 and, optionally, based on a further captured image obtained in step 708.

In some implementations, the item analyzer 420 may generate a 3D model of the physical item using photogrammetry, for example. Alternatively or additionally, the 3D model of the physical item may be based on a default shape obtained through identification of an item type corresponding to the physical item. The mesh of the 3D model may correspond to this default shape, while the texture map for the 3D model may be generated based on one or more images of the physical item. Optionally, the lighting conditions in the real-world space surrounding the physical item could be removed or normalized when generating the 3D model of the physical item to represent the physical item under generic lighting conditions.

In some implementations, the lighting conditions in the real-world space, the 3D shape of the physical item and/or the 3D position of the physical item may be received by the materials analysis engine 402 from another device. For example, this information may be obtained from an AR experience implemented at the user device 430.

Optionally, step 710 includes inputting at least a portion of the image and the lighting conditions into a ML model trained to identify material properties in images and obtaining, from an output of the ML model, an indication of the material properties related to the one or more materials from which the physical item is formed. Examples of ML models that may be implemented in step 710 are provided elsewhere herein.

Step 712 includes the processor 404 identifying, based on the material properties determined in step 710, a second item having material properties that are complementary to the determined material properties. In some implementations, step 712 could be performed using the item identifier 412. The second item may include a material that is the same type as the one or more materials from which the physical item is formed, and may include a material that is substantially the same as one of the materials from which the physical item is formed. However, this need not always be the case. The second item may also or instead include a material that is functionally and/or aesthetically complementary to the physical item. In some cases, design rules may be implemented in the form of a lookup table and/or decision tree to help select the second item.

It should be noted that step 712 is not limited to identifying a single item. In some cases, multiple items may be identified as having material properties that are complementary to the determined material properties of the physical item. The multiple items could be ranked and/or ordered based on how well the material properties of each item complements the determined material properties of the physical item. For example, items having material properties that are complementary in more than one way may be prioritized over other items.

In some implementations, criteria and/or filters provided by a user may be used to help identify items in step 712. For example, user-defined criteria and/or filters may limit step 712 to certain product categories, product types, product brands, product dimensions and/or a cost range. Only items that meet the user-defined criteria and/or filters might be considered in step 712. If multiple items are found to have material properties that are complementary to the determined material properties of the physical item, but only a subset of those items meets user-defined criteria, then the subset of items might be selected in step 712.

Step 714 includes the processor 404 generating digital media for display at the user device 430 and/or at another user device. The user device 430 may be associated with the same user that is associated with the physical item. By way of example, the user may have captured the at least one image of their physical item using the user device 430 and provided this at least one image to the materials analysis engine 402 in step 702. The user could then view the digital media generated in step 714 on the same user device 430. In some implementations, step 714 may be performed using the digital media generator 414.

The digital media generated in step 714 may include a representation of the second item and may also include a representation of the physical item. For example, the combination of the physical item and the second item may be depicted in the digital media. This may better demonstrate how the material properties of the second item complement the determined material properties of the physical item. However, in some cases, the digital media might only include a representation of the second item. For example, if the second item is selected to replace the physical item, then only the second item might be represented in the digital media.

In the case that multiple items are identified in step 712 as having material properties that are complementary to the determined material properties of the physical item, then the multiple items could be displayed in the digital media generated in step 714. Multiple instances of digital media may also or instead be generated to present each of the identified items.

In some implementations, the lighting conditions determined in step 710 may be applied to the digital media generated in step 714. The representation of the second item in the digital media may depict the second item being illuminated under the lighting conditions in the real-world space. Similarly, the representation of the first item in the digital media may depict the first item being illuminated under the lighting conditions in the real-world space. These lighting conditions may better illustrate the combination of the physical item and the second item in the real-world space. For example, the digital media may depict realistic shadows cast by the physical item and the second item as if they were both placed in the same real-world space.

In some implementations, the digital media may include or be based on a 3D model of the second item. For example, this 3D model may be rendered to produce the representation of the second item. The 3D model of the second item may include a texture map that depicts its material properties. For example, the texture map may include material models that simulate how the materials in the second item appear under the determined lighting conditions. These material models may include equations that define the diffuse, ambient and/or specular light interactions for the materials. Using the simulated illumination on a particular material, a material model for that material may output the appearance of the material. A bump map may further be used to simulate shadows on the surfaces of the 3D model. The 3D model of the second item may be stored at the materials analysis engine 402 and/or be obtained from an external repository.

Alternatively or additionally, the digital media may include or be based on a 3D model of the physical item, which may have been generated by the item analyzer 420 in step 710. The 3D model of the physical item may be rendered to produce the representation of the physical item. The 3D model of the physical item may include a texture map that depicts its material properties using material models that simulate how the materials in the physical item appear under the determined lighting conditions.

In some implementations, a composite 3D model may be generated based on 3D models of the physical item and the second item to depict the combination of the physical item and the second item in 3D. The composite 3D model may depict occlusions and/or other effects resulting from the combination of the physical item and the second item.

In some implementations, the digital media includes a 3D representation of one or more materials in the physical item and/or includes a 3D representation of one or more materials in the second item. A 3D model of the physical item may provide the 3D representation of the one or more materials in the physical item. Similarly, a 3D model of the second item may provide the 3D representation of the one or more materials in the second item. However, this need not always be the case. A 3D representation of a material in the physical item and/or in the second item may be provided separately from 3D models of the first item and the second item. For example, the 3D model of the second item may provide a relatively coarse depiction of the second item, while a detailed 3D representation of one or more materials in the second item are provided separately. A 3D representation of a material in the physical item and/or in the second item may also be provided when 3D models of the physical item and/or the second item are not used in the digital media.

A 3D representation of a material may depict a sample of the material in the form of a material swatch, for example. Optionally, the 3D representation of a material may be a 3D model of the material. This 3D model may be relatively detailed in order to illustrate the material properties of the material. A dense mesh may be used in the 3D model to illustrate at least some material properties (e.g., roughness). Alternatively or additionally, the 3D model may include a texture map corresponding to the material properties of the material. The texture map may include 3D texture information for the material in the form of a height map, for example. In some implementations, a bump map may be used to simulate bumps or wrinkles on the material. Advantageously, using a height map to add 3D texture may be more computationally efficient than adding the 3D texture using a dense mesh.

Implementing a 3D representation of one or more materials in an item separately from a full 3D model of the item may reduce the computational requirements associated with generating, storing and displaying the digital media in step 714. For example, a high-fidelity 3D model of the item might be required to provide a detailed 3D representation of a material in the item. A high-fidelity 3D model may include a detailed mesh reflecting the shape of the item and/or a detailed texture map depicting the surfaces of the item. However, the use of high-fidelity 3D models may be computationally intensive. For example, implementing high-fidelity models might involve storing large amounts of data. In web-based applications, this large amount of data may also need to be transmitted over the network 428 to the user device 430, which may be bandwidth intensive. Further, large amounts of processing power may be required to render high-fidelity 3D models. Therefore, the fidelity of the 3D model of the item may be limited to conserve computing resources and help ensure a consistent and smooth experience on the user device 430. The 3D representation of the one or more materials in the item may be displayed separately to provide a detailed depiction of the materials. Because the 3D representation might only depict a portion of the item, the computational requirements associated with generating, storing and rendering the 3D representation may be reduced.

### Further Examples

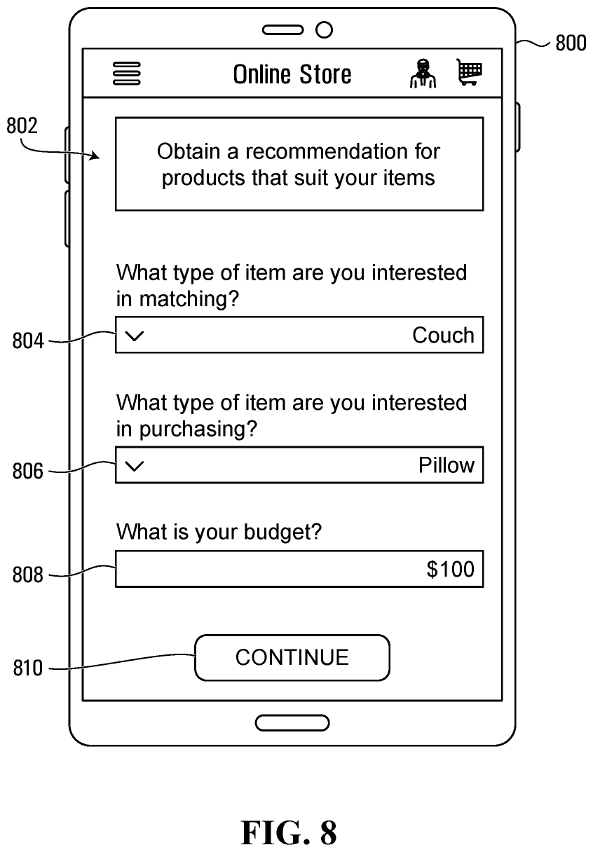

FIGS. 8 to 13 illustrate an example implementation of the method 700 to generate a product recommendation in an e-commerce setting. FIG. 8 illustrates a user device 800 displaying a screen page 802 of an online store. The screen page 802 enables a customer to configure a product recommendation based on criteria defined in two dropdown menus 804, 806 and a textbox 808. The customer may then request the product recommendation by selecting an option 810 in the screen page 802. Selection of the option 810 may transmit an HTTP or HTTPS message to a server hosting the online store instructing the server to initiate the method 700 of FIG. 7, for example.

The dropdown menu 804 enables the customer to select the type of item they currently own and are interested in matching with a recommended product. In the illustrated example, the customer has indicated that they are interested in products that match their “couch”. The dropdown menu 806 enables the customer to select the type of item they are interested in purchasing . Using the dropdown menu 806, the customer has indicated that they would like to purchase a “pillow”. The textbox 808 enables a customer to enter their budget for the recommended item, which is shown as “$100” in FIG. 8.

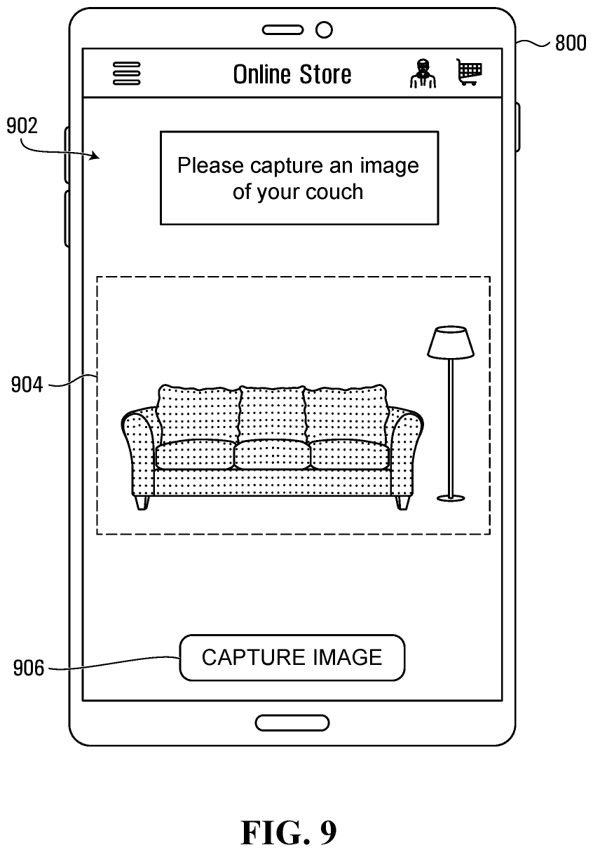

FIG. 9 illustrates the user device 800 displaying another screen page 902 of the online store, which may be presented on the user device 800 after the option 810 is selected in the screen page 802. The screen page 902 enables the customer to capture an image of their couch. In some cases, the image may be captured using a camera in the user device 800. A viewfinder 904 is provided in the screen page 902 to help guide the user during the image capture process. The screen page 902 also includes an option 906 to capture the image shown in the viewfinder 904.

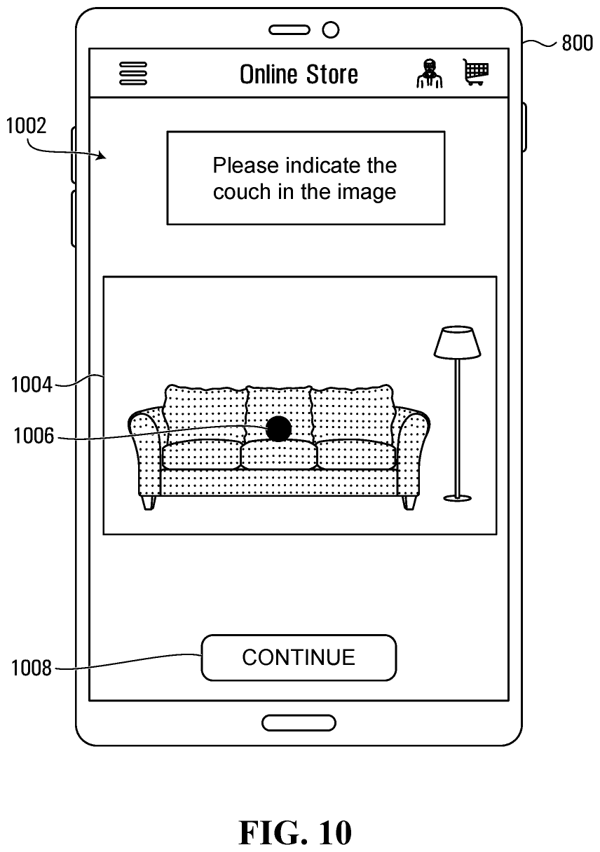

FIG. 10 illustrates the user device 800 displaying yet another screen page 1002 of the online store. The screen page 1002 may be presented on the user device 800 after an image is captured using the option 906 in the screen page 902. The screen page 1002 includes a captured image 1004 of the customer's couch. Using the screen page 1002, the customer may indicate the location of their couch in the image 1004 to aid in the identification and characterization of the couch through image analysis. The screen page 1002 includes a point 1006 corresponding to the location of the couch in the image 1004. The point 1006 may have been selected by the customer via user input at the user device 800. The screen page 1002 further includes an option 1008 to continue and obtain a product recommendation.

The screen pages 902, 1002 provide an example implementation of step 702 of the method 700. In some implementations, the image 1004 may be analysed to determine whether or not the material properties of the couch can be determined with sufficient accuracy. If it is determined in step 704 that image 1004 is sufficient to determine the material properties of the couch, then the product recommendation may be generated in steps 710, 712. Alternatively, if it is determined in step 706 that the image 1004 is insufficient to determine the material properties of the couch, then step 708 may be performed to obtain a further captured image of the couch. In this case, a screen page similar to the screen page 902 may be presented on the user device 800 instructing the customer to capture one or more further images of the couch to enable the material properties to be determined. Feedback for the customer may also be provided on the screen page to help the customer capture a better image of the couch. For example, this feedback could state “Increase the lighting in the room” or “Capture another image from the side”.

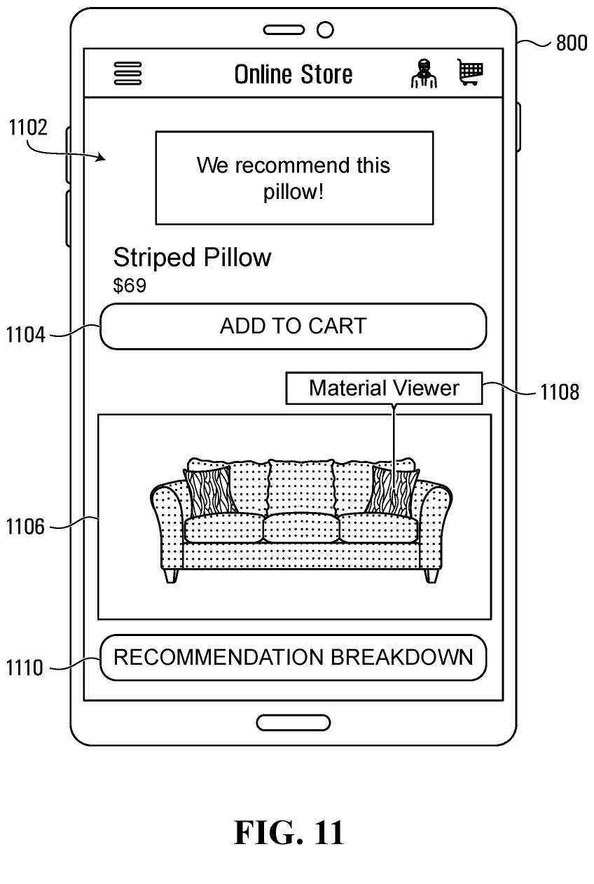

FIG. 11 illustrates the user device 800 displaying a further screen page 1102 of the online store. The screen page 1102 provides the product recommendation that was generated based on determined material properties of the customer's couch. In the illustrated example, the recommended product is a “Striped Pillow” sold in the online store. The screen page 1102 includes an option 1104 to purchase the Striped Pillow and digital media 1106 depicting two of the Striped Pillows resting on the customer's couch. In this way, the digital media 1106 includes a representation of the couch and representations of the Striped Pillow. The digital media 1106 may have been generated in step 714 of the method 700.

In some implementations, the digital media 1106 could be an image. For example, the image 1004 captured by the customer may have been modified to include the representations of the Striped Pillow. An image and/or 3D model of the Striped Pillow may have been used to obtain the representations of the Striped Pillow, which may have been overlaid onto the image 1004 to generate the digital media 1106. In some embodiments, the representations of the Striped Pillow may have been scaled based on the 3D shape and dimensions of the couch. The 3D shape and dimensions of the couch could have been determined based, at least in part, on analysis of the image 1004.

In some implementations, the digital media 1106 could be a 3D model. For example, a 3D model of the couch may have been generated or otherwise obtained based on the image 1004. This 3D model might include a mesh corresponding to a default couch shape and a texture map that corresponds to the image 1004. Alternatively or additionally, the 3D model of the couch may be generated through photogrammetry. A 3D model of the Striped Pillow may be combined with the 3D model of the couch to obtain a composite 3D model that forms the digital media 1106. This 3D model of the Striped Pillow may have been obtained from a product media repository associated with the online store. The customer may be able to manipulate (e.g., move and rotate) the composite 3D model via user input at the user device 800. The customer may also or instead be able to reposition the Striped Pillows relative to the couch in the composite 3D model.

The screen page 1102 further includes an option 1108 to view a material in the Striped Pillow in greater detail and an option 1110 to view an explanation of the product recommendation process.

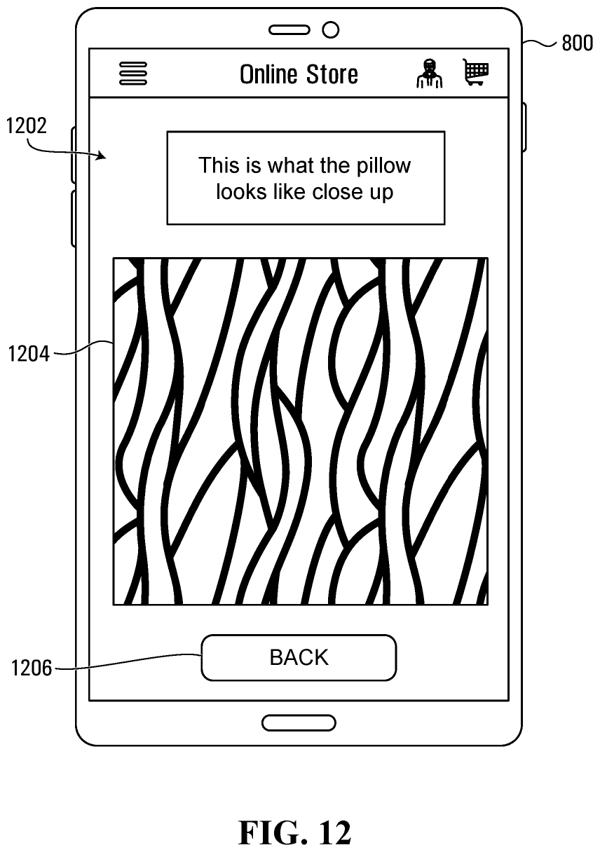

FIG. 12 illustrates the user device 800 displaying yet another screen page 1202 of the online store, which includes a 3D representation 1204 of a material in the Striped Pillow. The screen page 1202 may be presented on the user device 800 in response to selection of the option 1108 in the screen page 1102. The 3D representation 1204 shows the fabric used in the Striped Pillow at a high level of detail (e.g., at a higher level of detail than the digital media 1106 in FIG. 11). In some cases, the 3D representation 1204 may be considered a material swatch for the fabric. The 3D representation 1204 may be based on a 3D model of the fabric, which may include a detailed texture map depicting the material properties of the fabric. For example, the 3D model may include a bump map representing the fabric.

The screen page 1202 also includes an option 1206 to return to the screen page 1102.

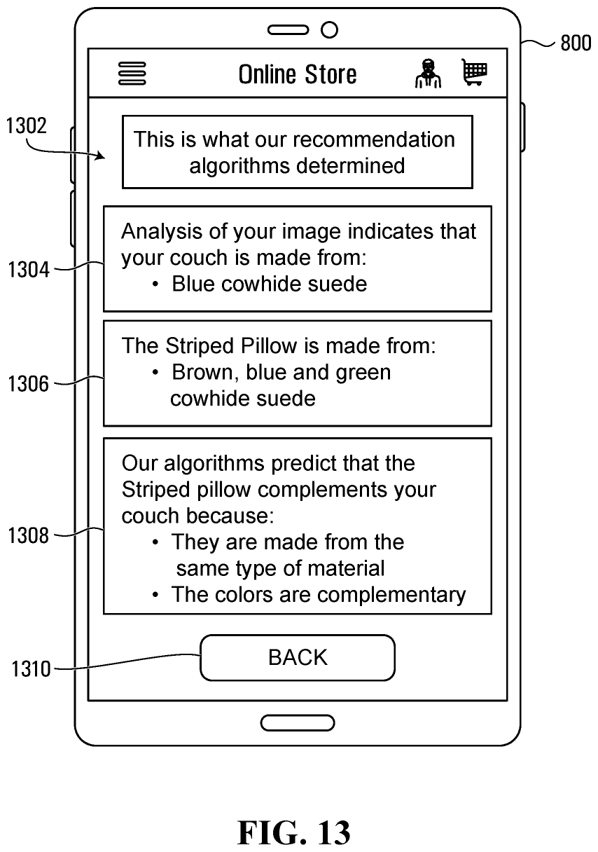

FIG. 13 illustrates the user device 800 displaying a further screen page 1302 of the online store, which may have been provided in response to selection of the option 1110 in the screen page 1102. The screen page 1302 outlines the analysis performed to generate the recommendation of the Striped Pillow. A textbox 1304 outlines the analysis performed on the image 1004 and, optionally, on other images of the couch. The textbox 1304 indicates that the image analysis determined the couch is formed, at least in part, from a blue cowhide suede material. Cowhide suede is an example of a type of material.

A textbox 1306 in the screen page 1302 outlines a material in the Striped Pillow. Illustratively, the Striped Pillow is made from brown, blue and green cowhide suede.

A textbox 1308 in the screen page 1102 outlines how the materials in the Striped Pillow complement the materials in the couch. The textbox 1308 indicates that the Striped Pillow and the couch are made from the same type of material, and that the colors of the Striped Pillow and complementary to the colors of the couch.

The screen page 1302 further includes an option 1310 to return to the screen page 1102.

### CONCLUSION

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

1. A computer-implemented method comprising:
obtaining at least one captured image of a physical item associated with a user;
determining, based on the at least one captured image, material properties related to one or more materials from which the physical item is formed, the material properties including at least a type of the one or more materials;
identifying, based on the determined material properties, a second item having material properties that are complementary to the determined material properties; and
generating digital media for display at a user device associated with the user, the digital media comprising a representation of the first item and the second item.

2. The method of claim 1, wherein the determined material properties comprise at least one of roughness, ambient reflectivity, diffuse reflectivity or specular reflectivity.

3. The method of claim 1, wherein the second item includes a material that is the same type as the one or more materials from which the physical item is formed.

4. The method of claim 1, wherein the digital media comprises a three-dimensional (3D) representation of the one or more materials from which the physical item is formed.

5. The method of claim 1, wherein the digital media comprises a three-dimensional (3D) representation of a material in the second item.

6. The method of claim 1, further comprising:
determining that the at least one captured image is sufficient to determine the material properties related to the one or more materials from which the physical item is formed.

7. The method of claim 1, further comprising:
determining that the at least one captured image is insufficient to determine the material properties related to the one or more materials from which the physical item is formed; and
obtaining a further captured image of the physical item,
wherein determining the material properties related to the one or more materials from which the physical item is formed is based on the further captured image.

8. The method of claim 1, further comprising:
estimating lighting conditions in a real-world space surrounding the physical item,
wherein determining the material properties related to the one or more materials from which the physical item is formed is based on the lighting conditions and light interactions on a surface of the physical item as depicted in the image.

9. The method of claim 8, further comprising:
determining a three-dimensional (3D) shape of the physical item and a position of the physical item in the real-world space,
wherein determining the material properties related to the one or more materials from which the physical item is formed is based on the 3D shape of the physical item and the position of the physical item in the real-world space.

10. The method of claim 8, wherein determining the material properties related to the one or more materials from which the physical item is formed comprises:
inputting at least a portion of the image and the lighting conditions into a machine learning (ML) model trained to identify material properties in images; and
obtaining, from an output of the ML model, an indication of the material properties related to the one or more materials from which the physical item is formed.

11. The method of claim 8, wherein the representation of the second item in the digital media depicts the second item being illuminated under the lighting conditions in the real-world space.

12. The method of claim 1, wherein generating the digital media is based on a three-dimensional (3D) model of the second item.

13. The method of claim 12, wherein the 3D model of the second item comprises a texture map corresponding to the material properties of the second item.

14. The method of claim 12, wherein the 3D model of the second item is a second 3D model and generating the digital media is further based on a first 3D model of the physical item.

15. The method of claim 14, wherein generating the digital media comprises generating the first 3D model using photogrammetry.

16. A system comprising:
memory to store at least one captured image of a physical item associated with a user; and
at least one processor to:
determine, based on the at least one captured image, material properties related to one or more materials from which the physical item is formed, the material properties including at least a type of the one or more materials;
identify, based on the determined material properties, a second item having material properties that are complementary to the determined material properties; and
generate digital media for display at a user device associated with the user, the digital media comprising a representation of the first item and the second item.

17. The system of claim 16, wherein the second item includes a material that is the same type as the one or more materials from which the physical item is formed.

18. The system of claim 16, wherein the digital media comprises a three-dimensional (3D) representation of the one or more materials from which the physical item is formed.

19. The system of claim 16, wherein the digital media comprises a three-dimensional (3D) representation of a material in the second item.

20. The system of claim 16, wherein the at least one processor is to determine that the at least one captured image is sufficient to determine the material properties related to the one or more materials from which the physical item is formed.

21. The system of claim 16, wherein the at least one processor is to:
determine that the at least one captured image is insufficient to determine the material properties related to the one or more materials from which the physical item is formed; and
obtain a further captured image of the physical item,
wherein the material properties related to the one or more materials from which the physical item is formed are determined based on the further captured image.

22. The system of claim 16, wherein the at least one processor is to:
estimate lighting conditions in a real-world space surrounding the physical item,
wherein the material properties related to the one or more materials from which the physical item is formed are determined based on the lighting conditions and light interactions on a surface of the physical item as depicted in the image.

23. The system of claim 22, wherein the at least one processor is to:
determine a three-dimensional (3D) shape of the physical item and a position of the physical item in the real-world space,
wherein the material properties related to the one or more materials from which the physical item is formed are determined based on the 3D shape of the physical item and the position of the physical item in the real-world space.

24. The method of claim 22, wherein:
the memory is to store a machine learning (ML) model trained to identify material properties in images; and
the at least one processor is to input at least a portion of the image and the lighting conditions into the ML model and obtain, from an output of the ML model, an indication of the material properties related to the one or more materials from which the physical item is formed.

25. A non-transitory computer readable medium storing computer executable instructions which, when executed by a computer, cause the computer to:
obtain at least one captured image of a physical item associated with a user;
determine, based on the at least one captured image, material properties related to one or more materials from which the physical item is formed, the material properties including at least a type of the one or more materials;
identify, based on the determined material properties, a second item having material properties that are complementary to the determined material properties; and
generate digital media for display at a user device associated with the user, the digital media comprising a representation of the first item and the second item.
